(19) United States
(12) Patent Application Publication
(10) Pub. No.: US 2005/0015458 A1
(43) Pub. Date: Jan. 20, 2005

(54) Home appliance network system and method for operating the same

(75) Inventor: In Hwan La, Kyungki-do (KR)

Correspondence Address: JONATHAN Y. KANG, ESQ.;LEE, HONG, DEGERMAN, KANG & SCHMADEKA, 14th Floor, 801 S. Figureroa Street, Los Angeles, CA, 90017, US

(73) Assignee: L.G Electronics Inc.

(21) Appl. No.: 10/875,747

(22) Filed: Jun. 23, 2004

(30) Foreign Application Priority Data
Jul. 14, 2003 (KR) 2003-47840

(51) Int. Cl. G06F 15/16

(52) U.S. Cl. 709/208

(57) ABSTRACT

A home appliance network system and a method for operating the same. The home appliance network system enables a home server to detect a connection state between individual home appliances and a network, such that it can automatically assign an IP address. The home appliance network system includes: a plurality of home appliances connected to a network implemented to perform a home-appliance networking function; and a home server for initially assigning an IP (Internet Protocol) address identifying the home appliances, assigning a local IP address when the home appliances are not connected to the network, and automatically resetting an IP address when the home appliances are re-connected to the network. The home appliance network system can assign a local IP address to a home appliance such that the home server can control the home appliance even though a current network connection state is indicative of a non-connection state. Therefore, the home server can continuously and stably control and monitor a plurality of home appliances at all times, such that it can provide a user with a highly reliable home appliance network system.

### BACKGROUND OF THE INVENTION

1. Field of the Invention

The present invention relates to a home appliance network system and a method for operating the same, and more particularly to a home appliance network system and a method for controlling the same, which can enable a home server to detect a connection state between individual home appliances and a network, such that it can automatically assign an IP address.

2. Description of the Related Art

In recent times, there have been widely used home network systems which can interconnect a plurality of home appliances contained in a house over a single network, connect the network with an external Internet, such that the home appliances can be controlled in individual homes or at a remote site.

FIG. 1 is a schematic diagram illustrating a conventional home appliance network system.

The home appliance network system (also called a home network system) includes a plurality of home appliances 2 contained in a house or building and a network capable of transmitting/receiving data, such that it can control the home appliances 2 to interact with each other over the network.

The home appliance network system can be classified into a variety of network systems according to category information of the network, for example, a phone-line networking system, an Intercompany standard networking system, an Interhome local wireless networking system, and a power-line based networking system, etc.

In this case, a user of the home appliance network system can enter his or her desired control command in the home appliances 2 connected to the network, and can centrally control the home appliances 2 using the home server 1 capable of generating operation state information according to the control command.

In order to implement the aforementioned home appliance network system, an internal network composed of power lines or LAN (Local Area Network) lines has been configured in a house or building, the home appliances 2 connected to the network and the home server 1 for controlling/monitoring the home appliances 2 are connected to the internal network.

Particularly, in recent times, the home appliance network system controls the home server to process control signals communicating with the home appliances 2 connected to the network, and includes a hardware module having an Internet module capable of communicating the control signals with the external network, such that it can connect the network with an interhome- or external-network and can enable a user to freely use the home appliances from anywhere he or she wishes.

The home appliances 2 have a function to carry out control commands received from the home server 1, have another function to transmit the control-command results to the home server 1, and include a microprocessor for processing data communicating with the network to carry out the above functions.

Upon establishing the network, the home appliance network system controls the home server 1 to detect the home appliances 2 connected to the network. In this case, the home server 1 assigns unique IP addresses capable of identifying individual home appliances to the home appliances 2, stores the assigned unique IP addresses, and establishes data transmission/reception with individual home appliances on the basis of the unique IP addresses assigned to the home appliances.

However, the aforementioned conventional home appliance network system loses the IP addresses assigned from the home server 1 when a connection state between the home appliances 2 and the LAN cable connected to the home appliances 2 is severed in a network composed of LAN lines. In this way, the home server 1 and the home appliances 2 can establish data communication with each other on the basis of such IP addresses, such that the home server 1 cannot control or monitor the home appliances 2 when the IP addresses have been lost.

Furthermore, if the connection state between the home appliances 2 and the network is unavoidably severed due to unexpected accidents even though the home appliances 2 are connected to either the LAN cable or other networks other than the LAN cable, the IP addresses assigned to the home appliances 2 are lost or deleted, such that the aforementioned home appliance network system cannot control or monitor the home appliances 2 using the home server 1.

### SUMMARY OF THE INVENTION

Therefore, the present invention has been made in view of the above problems, and it is an object of the invention to provide a home appliance network system which controls a home server to detect a non-connection state between home appliances and a home appliance network, and controls the home server to assign a local IP address for the non-connection state, such that a user can continue to control or monitor the home appliances using the home server.

In accordance with one aspect of the present invention, these objects are accomplished by providing a home appliance network system comprising: a plurality of home appliances connected to a network implemented to perform a home-appliance networking function; and a home server for initially assigning an IP (Internet Protocol) address identifying the home appliances, assigning a local IP address when the home appliances are not connected to the network, and automatically resetting an IP address when the home appliances are re-connected to the network.

Preferably, the home server may include an IP manager for assigning unique IP addresses to identify the individual home appliances during a data communication time, and resetting individual IP addresses according to connection state information associated with the network.

Preferably, the IP manager may include: an IP generator for generating IP addresses differently assigned to the home appliances when the network is initially connected to the home appliances; a connection-state detector for detecting in real time a connection state between the network and the home appliances; and an IP management controller for automatically generating a local IP address when either one of the home appliances is not connected with the network.

In accordance with another aspect of the present invention, there is provided a method for operating a home appliance network system, comprising the steps of: a) assigning IP addresses to a plurality of home appliances to identify the home appliances; b) detecting a connection state between the home appliances and a network; and c) if the connection state result is indicative of a non-connection state between either one of the home appliances and the network, assigning a local IP address to the home appliance not connected to the network.

Preferably, if the unconnected home appliance is re-connected to the network after performing the step c), a unique IP address is automatically reset.

The home appliance network system and its control method according to the present invention can assign a local IP address to a home appliance such that a home server can control the home appliance even though a current network connection state is indicative of a non-connection state. Therefore, the home server can continuously and stably control and monitor a plurality of home appliances at all times, resulting in increased reliability of a networking operation.

### BRIEF DESCRIPTION OF THE DRAWINGS

The above objects, and other features and advantages of the present invention will become more apparent after reading the following detailed description when taken in conjunction with the drawings, in which:

FIG. 1 is a schematic diagram illustrating a conventional home network system;

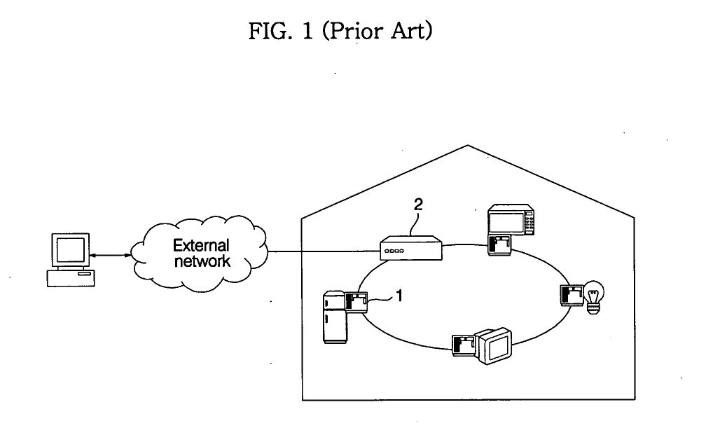

FIG. 2 is a block diagram illustrating a home appliance network system in accordance with a preferred embodiment of the present invention;

FIG. 3 is a block diagram illustrating a home appliance network system in accordance with another preferred embodiment of the present invention; and

FIG. 4 is a flow chart illustrating an operation method of the home appliance network system in accordance with the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

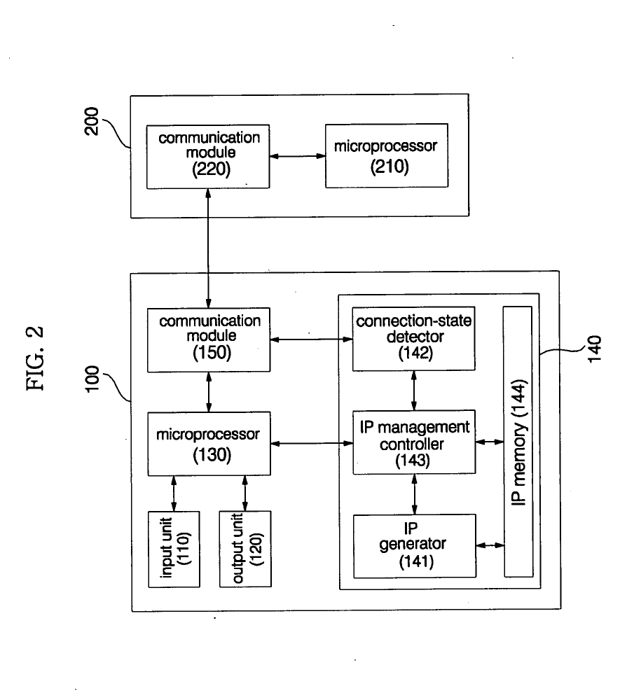

FIG. 2 is a block diagram illustrating a home appliance network system in accordance with a preferred embodiment of the present invention.

The home appliance network in accordance with a first preferred embodiment of the present invention includes a plurality of home appliances 200 capable of establishing data communication over a network implemented in a house or building, and a home server 100 for transmitting/receiving data to/from the home appliances 200 over the network so that it can monitor state information of the home appliances 2 or control operations of the same.

The home appliances 200 each include a communication module 200 capable of establishing data communication over the network and a microprocessor 210. The microprocessor 210 controls overall operations of the home appliances 2, and at the same time controls operations of the home appliances 2 upon receiving a control command from the network. If necessary, the microprocessor generates response data, and transmits the generated response data to the network.

The home server 100 is connected to the network over a communication module 150 for data transmission/reception, so that it can enter a control command to the home appliances 200. The home server 100 outputs the control-command result to an external device, such that a user of the home appliance network system can recognize the control-command result. The home server 100 includes a microprocessor 140 having enough processing capacity and memory capacity to process signals communicating with the home appliances 2, an input unit 110 for receiving user-desired control commands, and an output unit 120 for generating the control-command result.

In this case, the input unit 100 can be configured in the form of a touch screen integrated with the output unit 120. The output unit 120 may be implemented in the form of a monitor or touch screen directly connected to a main frame of the home server 100, or may also use a Webpad detachably connected with the home server 100, a computer monitor, or independent video devices such as a TV (television) for outputting video signals through the use of the network or additional connection devices.

The home server 100 further includes an IP manager 140. The IP manager 140 identifies individual home appliances 200, and assigns unique IP addresses to the home appliances 200 to independently control the home appliances 200, and maintains or resets individual unique IP addresses according to its state information associated with the network.

The IP manager 140 includes an IP generator 141 for generating unique IP addresses differently assigned to the home appliances when the network is initially connected to the home appliances 200, a connection-state detector 142 for detecting in real time a connection state between the network and the home appliances 200, and an IP management controller 143 for automatically generating a local IP address when either one of the home appliances is not connected with the network.

The IP manager 140 further includes an IP memory 144 for storing/updating either unique IP addresses having been assigned to individual home appliances 200 by means of the IP generator 141 or local IP address.

The IP generator 141 can generate unique IP addresses for identifying when the network is initially connected to the home appliances or a new home appliance is further connected to the network, can transmit the unique IP addresses to the home appliances, and can generate a local IP addresses according to a control signal of the IP management controller 143.

The connection-state detector 142 checks in real time the variation of IP addresses assigned to the home appliances 200. If the IP address assigned to any one of the home appliances is not detected, the connection-state detector determines the connection state between the home appliances and the network.

If the connection-state detector 142 determines that the home appliance for changing the IP address to another address has not been connected to the network, the IP management controller 143 controls the IP generator 141 to automatically generate a local IP address, and assigns the local IP address to the home appliances, such that it can continue to virtually monitor state information of the home appliance.

The IP management controller 143 deletes the assigned local IP address when the home appliance assigned with the local IP address re-accesses the network, resets a unique IP address for the home appliance re-accessed via the IP generator 141, and transmits the reset unique IP address to the home appliance.

Therefore, although the home appliances 200 assigned with unique IP addresses are not connected to the network so that the unique IP addresses corresponding to the home appliances disappear, the home appliance network system of FIG. 2 can continue to control its typical operations or its typical state monitoring operations whereas the conventional art cannot perform such typical operations.

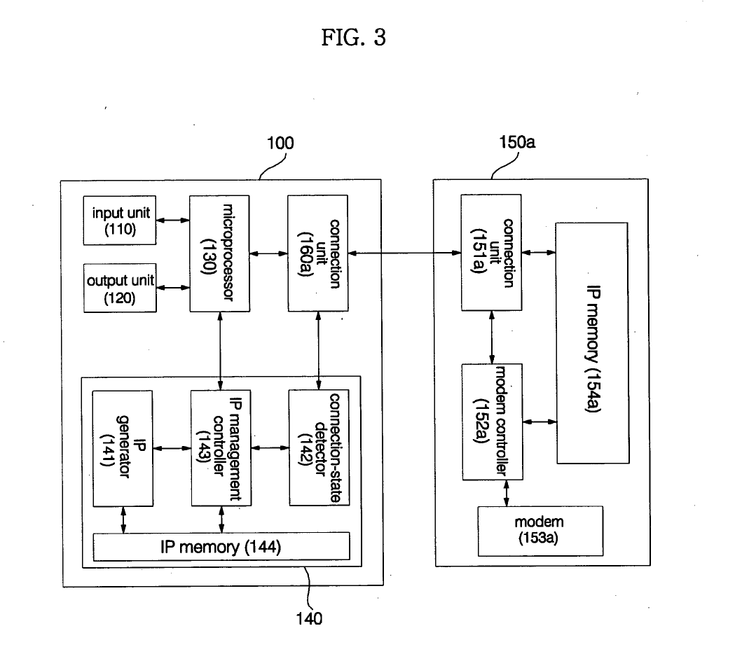

FIG. 3 is a block diagram illustrating a home appliance network system in accordance with another preferred embodiment of the present invention. Except for a communication module, the home appliance network system of FIG. 3 is substantially similar to the aforementioned home appliance network system of FIG. 2, so that the same elements other than the communication module are denoted by the same reference numerals even though they are depicted in different drawings, and its detailed description will herein be omitted for the convenience of description.

In more detail, the home appliance network system has not been limited to a specific network, such that it additionally connects a communication module for the specific network to the home server or home appliances, and it can be implemented using a variety of networks.

Therefore, as shown in FIG. 3, the home server 100 and the home appliance 200 according to the second preferred embodiment of the present invention each include a communication module connection unit 160a connected to a communication module 150a to transmit/receive data to/from the communication module 150a. In this case, the communication module connection unit 160a can be compatible with a variety of data transmitters built in the home server 100, for example, a serial port, a parallel port, a USB port, a Bluetooth device, and an IrDA device, etc.

The communication module 150a includes a connection unit 151a for transmitting data communicating with the home server 100 over the network, a memory 154a for storing information associated with an IP address for the home server 100's network, a modem 153a for converting data communicated between the home server 100 and the network into other data according to predetermined communication standard information, and a modem controller 154a for controlling the modem 153a.

The aforementioned communication module can also be connected to the home appliances 200.

Particularly, the IP manager 140 is contained in the communication module 150 and 150a in accordance with the above first and second preferred embodiments of the present invention, such that it can perform the same function in the first and second preferred embodiments.

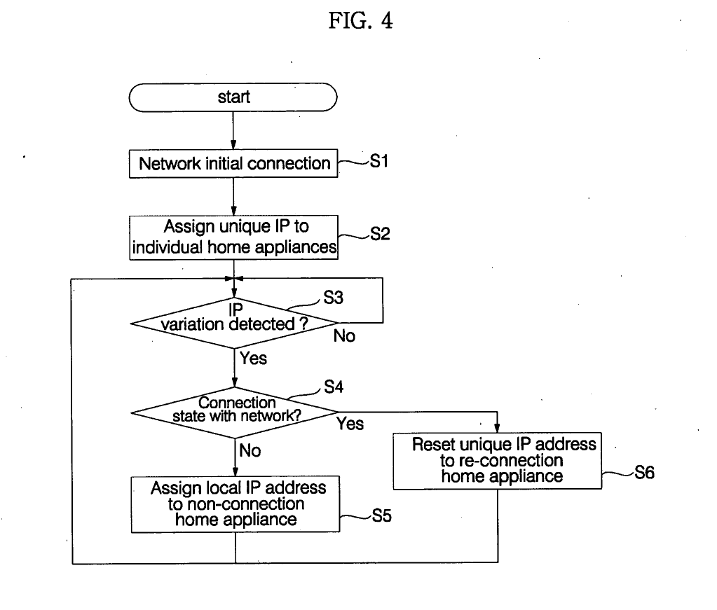

A method for operating the aforementioned home appliance network system will hereinafter be described with reference to FIG. 4. FIG. 4 is a flow chart illustrating an operation method of the home appliance network system in accordance with the present invention.

Although the present invention is not limited to a specified network, the present invention exemplarily discloses a home appliance network system including a network configured with a LAN cable for illustrative purposes.

If a network is implemented using the LAN cable so that the home server is initially connected to the home appliances at step S1, the home server detects the home appliances connected to the network, and automatically assigns unique IP addresses for identifying individual home appliances to the home appliances at step S2.

The home server controls or monitors in real time the home appliances using the IP addresses assigned to the home appliances, and at the same time can detect the variation of IP addresses assigned to the home appliances at step S3.

In this case, if the variation of IP address occurs, the home server determines whether the variation of IP address is caused by a connection state of the network including the LAN cable at step S4. In the case where the connection state between one home appliance and the LAN cable is severed so that a non-connection state is provided, the home server assigns a local IP address to the severed home appliance at step S5.

In this case, the IP manager of the home server stores the local IP address assigned to the home appliance.

If it is determined that the unconnected home appliance assigned with the local IP address is not connected to the network while monitoring the network connection state, the home server automatically deletes the local IP address assigned to the home appliance, resets a unique IP address, and assigns the reset unique IP address to the home appliance, such that it can control operations of individual home appliances or can monitor state information of the home appliances according to the assigned IP addresses at step S6.

As stated above, the home appliance network system and a method for controlling the same according to the present invention can assign a local IP address to a home appliance such that a home server can control the home appliance even though a current network connection state is indicative of a non-connection state. Therefore, the home server can continuously and stably control and monitor a plurality of home appliances at all times, such that it can provide a user with a highly reliable home appliance network system.

As apparent from the above description, the present invention configures a new network when an additional communication module is contained in a home appliance network system, such that it can use the new network using the communication module without using a home server and home appliances adapted to establish data transmission/reception over the network, resulting in increased compatibility and reduced production costs for network system implementation.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

1. A home appliance network system comprising:
a plurality of home appliances connected to a network implemented to perform a home-appliance networking function; and
a home server for initially assigning an IP (Internet Protocol) address identifying the home appliances, assigning a local IP address when the home appliances are not connected to the network, and automatically resetting an IP address when the home appliances are re-connected to the network.

2. The home appliance network system according to claim 1, wherein the home server includes:
a microprocessor for processing data transmitted/received over the network, and performing a state monitoring function or operation control function state of the home appliances; and
an IP manager for assigning unique IP addresses to identify the individual home appliances during a data communication time, and resetting individual IP addresses according to connection state information associated with the network.

3. The home appliance network system according to claim 2, wherein the IP manager includes:
an IP generator for generating IP addresses differently assigned to the home appliances when the network is initially connected to the home appliances;
a connection-state detector for detecting in real time a connection state between the network and the home appliances; and
an IP management controller for automatically generating a local IP address when either one of the home appliances is not connected with the network.

4. The home appliance network system according to claim 3, wherein the IP manager further includes:
an IP memory for storing unique IP addresses assigned to individual home appliances or the local IP address.

5. The home appliance network system according to claim 2, wherein the home server further includes:
a communication module for enabling the home appliances to establish data communication over the network;
an input unit for receiving a control command of the home appliances from a user; and
an output unit for generating state information data of the home appliances connected to the network upon receiving a control signal from the microprocessor.

6. The home appliance network system according to claim 5, wherein the communication module includes:
a memory for storing information associated with an IP address for the home server's network;
a modem for converting data communicated between the home server and the network into other data according to predetermined communication standard information; and
a modem controller for controlling the modem.

7. The home network system according to claim 5, wherein the output unit is configured in the form of a touch screen integrated with the input unit.

8. The home appliance network system according to claim 5, wherein the output unit is detachably coupled with a main frame of the home server.

9. The home appliance network system according to claim 2, wherein the home server further includes:
a communication module connected to the home server so that it can establish data communication with the home appliances over the network.

10. The home appliance network system according to claim 9, wherein the communication module includes:
a connection unit for transmitting data communicating with the home server over the network;
a memory for storing information associated with an IP address for the home server's network;
a modem for converting data communicated between the home server and the network into other data according to predetermined communication standard information; and
a modem controller for controlling the modem.

11. A method for operating a home appliance network system, comprising the steps of:
a) assigning IP addresses to a plurality of home appliances to identify the home appliances;
b) detecting a connection state between the home appliances and a network; and
c) if the connection state result is indicative of a non-connection state between either one of the home appliances and the network, assigning a local IP address to the home appliance not connected to the network.

12. The method according to claim 11, wherein the step b) includes the steps of:
b1) determining whether unique IP addresses assigned from the home appliances are changed to others; and
b2) detecting a connection state between the home appliances and the network.

13. The method according to claim 12, wherein the step c) includes the steps of:
c1) automatically generating a local IP address when the home appliances are not connected to the network; and
c2) assigning the local IP address to a unconnected home appliance, and monitoring state information of the home appliance.

14. The method according to claim 13, further comprising the step of:
d) if the unconnected home appliance is re-connected to the network after performing the step c), automatically resetting a unique IP address.
